(19) United States
(12) Patent Application Publication
(10) Pub. No.: US 2026/0022044 A1
(43) Pub. Date: Jan. 22, 2026

(54) Matchas Antioxidant Mediated Chlorine Neutralization In Water Treatment

(71) Applicant: Sahara Leeser, West Linn, OR (US)

(72) Inventor: Sahara Leeser, West Linn, OR (US)

(21) Appl. No.: 18/778,964

(22) Filed: Jul. 20, 2024

(51) Int. Cl. C02F 3/32; C02F 1/76

(52) U.S. Cl. CPC C02F 3/327; C02F 1/76; C02F 2303/185

(57) ABSTRACT

The process of using matcha to decrease chlorine concentration in the water purification process. The process includes adding matcha after the use of chlorine and properly dissolving the matcha into the chlorinated water. The matcha itself is in powdered form to increase surface area and results. In addition, the matcha also decreases the taste associated with chlorine covering it with its flavonoids. Other embodiments are described or shown.

### FIELD

The present application refers to a process of dechlorination in water treatment using the organic compound, matcha.

### BACKGROUND OF THE INVENTION

The present disclosure pertains to technologies for chlorine remediation

Halide chemical remediation in water treatment is the practice of using mechanics or chemicals to reduce halide concentration in water. This practice is necessary to prevent halide chemicals in potable water. This prevents chemical poisonings and other health risks. Halide remediation tends to be performed at the end of the treatment cycle. Exemplary technologies for halide remediation in potable water treatment are carbon filters and evaporation, commonly used in municipal and personal water treatment, respectively. Although common, these processes tend to have drawbacks. For example, evaporation takes up to 36 hours yet still does not completely neutralize the halide. This treatment time though common is excessive. In contrast, on the industrial scale, activated charcoal filters tend to be quick and efficient but require high maintenance and can ironically be a source of bacteria, defeating the effectiveness of halide-based water treatment. An additional persistent challenge of halide remediation in water treatment is the ever-growing chemical doses needed to effectively combat increasingly resistant bacteria. For these reasons, alternative approaches and technologies for halide remediation continue to be needed. In addition, employment of a matcha processing step as suggested by the invention disclosed herein offers the additional benefit of neutralizing the stereotypical chemical after taste.

### SUMMARY

The general purpose of this invention, which will be described in greater detail subsequently, relates to the deployment of a polyphenol containing antioxidants such as matcha in water treatment to decrease chlorine treatment time, improve treated water taste and reduce maintenance.

In view of the many disadvantages of halide remediation systems in prior art, the present invention provides a new process using matcha's chemical composition, whether organic or synthetic as an antioxidant, a chemical with a special structure that inhibits the process of oxidation from free radicals, and is used to react with halide free radical chemicals like chlorine, fluorine, bromine, and iodine. When matcha is added subsequent to the addition of the halide free radical, matcha inhibits oxidation of the halide free radical by donating one of its electrons to the free radical, stabilizing the chemistry.

A second embodiment of matcha's use in water treatment is the fact that matcha has polyphenols including flavonoids, a catechin, that can be used to overpower the flavor of chlorine.

To achieve this desirable effect, the use of powdered matcha is essential to decrease dissolution time and increase the effectiveness of this reaction. The powder particles are between 10 and 15 microns in diameter or further refined into particles between 5 and 10 microns in diameter or further refined into particles between 1 and 5 microns in diameter. The user must go through all the proper purification procedures until the addition of the halide free radical chemical. After the addition of the chemical the user must add matcha of the Theaceae family, specifically of the genus Camellia, and dissolve a dosage of 0.4 mg per quart in the contaminated water for 10 minutes at a temperature less than 100° C. and pressure is less than 20 psig.

### BRIEF DESCRIPTION OF THE DRAWINGS

The present disclosure will become more fully understood from the detailed description and the accompanying drawings, wherein:

FIG. 1 is a diagram showing the tradition large scale water treatment process;

FIG. 2 illustrates a proposed change to the process of water treatment, according to the present disclosure;

FIG. 3 depicts a diagram of chlorine treatment system:

FIG. 4 depicts a diagram of a proposed at home chlorine water treatment system, according to the present disclosure;

FIG. 5 portrays data from experiments run to show tea types and their ability to decrease chlorine concentration, according to the present disclosure;

FIG. 6 illustrates data showing the effectiveness of the proposed invention, according to the present disclosure;

### DETAILED DESCRIPTION OF EMBODIMENTS

While the disclosed method may have embodiments in many different forms, there is shown in the drawings and will herein be described in detail several specific embodiments with the understanding that the present disclosure is to be considered as an exemplification of the principles of the method and is not intended to limit the method to the embodiments illustrated. The terminology used herein is for the purpose of describing particular embodiments and is not intended to limit the method.

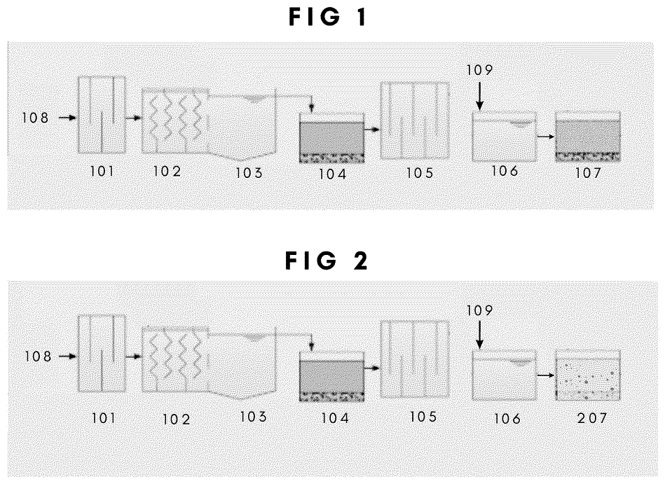

FIG. 1 illustrates the prior art of a conventional water purification system commonly found in water treatment plants using a carbon filter. 108 indicates the source water. The source water is where the water that needs to be purified is coming from. 101 indicates an ozone container or an ozone treatment tank. This sort of treatment is used to remove bacteria, viruses and cysts. 102 shows a flocculation tank. Flocculation is the use of a type of chemical with the property of binding larger particles together. 103 is a sedimentation tank. A sedimentation tank removes debris. 104 denotes the location of a sand filter. Working to remove flocs the sand filter allows particle bunches made by flocculation to be removed. 105 shows another ozone tank that is to remove debris, bacteria, and viruses. 106 denotes the location of a clear water tank or the tank where the chemical disinfectant 109 is added. The addition of this chemical kills bacteria, viruses, and other microorganism. Chemical disinfectants are commonly halogens such as chlorine-, fluorine-, bromine-, or iodine-containing compounds. In municipal water treatment systems, examples of such compounds are sodium hypochlorite or calcium hypochlorite. 107 indicates a BAC (Biological Activated Carbon) filter. These filters are used to filter out or otherwise remove organic chemical compounds.

In accordance with FIG. 1, steps 101-109 are the same between FIG. 1 and FIG. 2.

FIG. 2 illustrates an improved water treatment system using matcha of the present invention. 207 indicates matcha being added. Matcha is utilized to react with the free radical halogen as an antioxidant and a polyphenol. These properties make it so matcha can donate an extra electron to the halogen creating a non-reactive form of the halogen. The main polyphenol in matcha is epigallocatechin gallate, a type of catechin. Although the primary focus of this invention is on naturally occurring polyphenols, synthetic polyphenols are emerging in the pharmaceutical industry. The application of synthetic polyphenols may enhance the cost effectiveness of the proposed invention on the industrial scale.

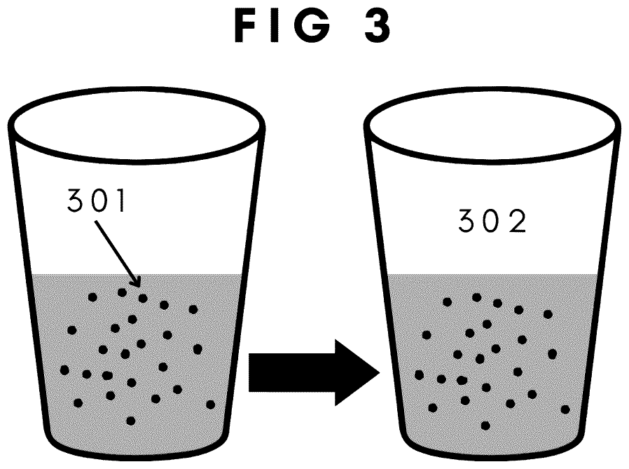

FIG. 3 depicts the prior art of a traditional emergency/at-home water treatment process. 301 shows disinfectant chemicals being added to a cup of non-potable water. Chemical disinfectants are commonly halogens such as chlorine-, fluorine-, bromine-, or iodine-containing compounds. In personal water treatment systems, an example of such a compound is tetraglycine hydroperiodide and sodium dichloroisocyanurate. A disinfectant chemical is added to kill the bacteria, viruses, etc. 302 exhibits the wait time needed to finish the water treatment. This wait time can range from 4 to 36 hours. Wait times are necessary to ensure adequate evaporation of these disinfection chemicals.

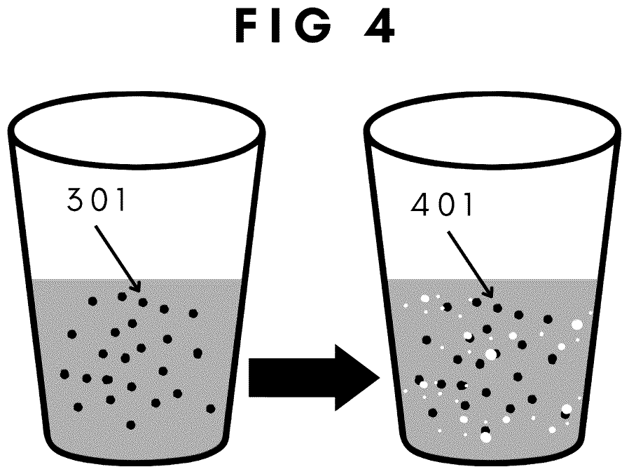

In accordance with FIG. 3, The first step, 401 is shared between FIG. 3 and FIG. 4.

FIG. 4 illustrates the prior art of a traditional emergency/at home disinfectant water treatment process with the addition of matcha. 401 exhibits matcha being added to a cup of water that is contaminated in a 0.4 mg dose per quart of water.

Whether it be industrial or personal the antioxidant and polyphenol containing ingredient is natural matcha, a powdered green tea. The green tea is pulverized into a powder whose particles are between 10 and 15 micrometers in diameter or further refined into particles between 5 and 10 microns in diameter or further refined into particles between 1 and 5 microns in diameter. This allows for a quicker wait time of 10 min. The matcha should be in the Theaceae family and more specifically from the genus Camellia. This process is preferable at standard temperature and pressure conditions. The temperature could be higher but should be less than 100 C. The pressure in the system must be lower than 20 psig.

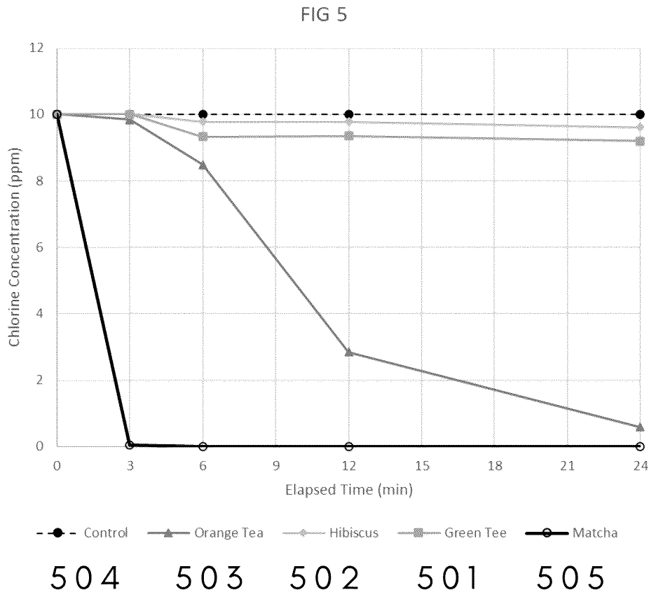

FIG. 5 portrays the data from a test run comparing matcha's antioxidant abilities to other tea varieties. 501 shows green tea. Green tea is an unrefined form of matcha. Green tea is grown on large farms hitting direct sun and the leaves are old while matcha uses young leaves creating the vibrant green color. On the graph green tea starts at 10 ppm going to 9 ppm and staying basically constant. 502 illustrates hibiscus tea. Hibiscus tea on the graph stayed close to 10 ppm. 503 is orange tea. Orange tea was able to decrease the chlorine concentration but it took 24 min. and orange tea did not totally decrease the chlorine concentration leaving it at 1 ppm. 504 illustrates the control. The control is chlorinated water with nothing else added. 505 displays matcha. Matcha works quickly with the surprising result of taking the amount of chlorine from 10 ppm to 0 ppm in 3 min.

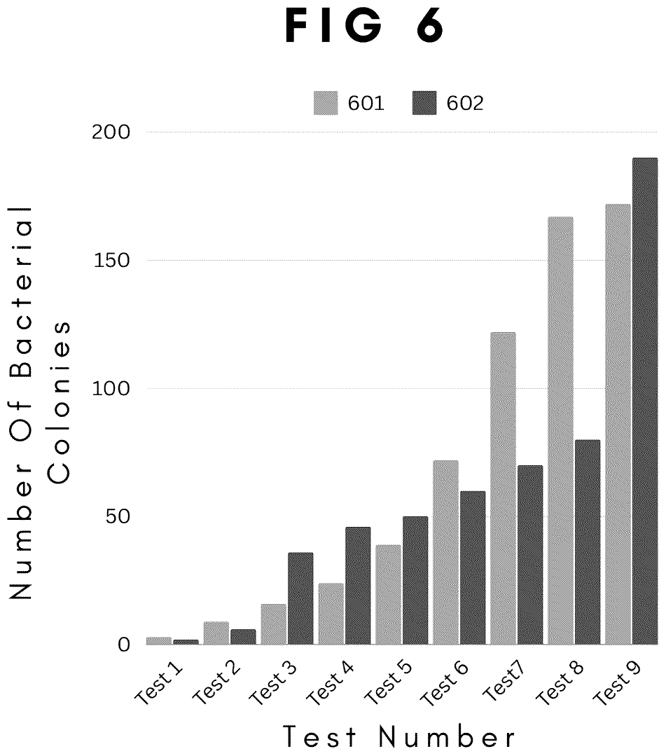

FIG. 6 illustrates the data from a test run comparing bacteria in just chlorine-treated water versus bacteria in chlorine-treated water with matcha added. This test was done to prove that matcha will not inhibit the abilities of chlorine to kill bacteria. The bacteria used was Escherichia Coli K 12. The data was sorted for greatest to least bacterial colonies. This was so it would be easier to see the similarities. The results illustrated by the graph shows the improved performance of chlorine and matcha as compared to chlorine alone. To further prove this the averages for the data were 69 colonies for chlorine alone and 61 for chlorine and matcha combined.

The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the disclosure for various embodiments with various modifications as are suited to the particular use contemplated.

What is claimed is:

1. A water purification process comprising the sequential application of a first halide chemical and an antioxidant and polyphenol-containing second chemical at a temperature and pressure.

2. The water purification process of claim 1 where the first halide chemical is one of chlorine or iodine or bromine and preferably chlorine.

3. The water purification process of claim 1 wherein the antioxidant and polyphenol containing ingredient is natural matcha, a powdered green tea.

4. The water purification process of claim 3 wherein the matcha is derived from the leaves of plants of the Theaceae family and more specifically from the genus Camellia and more specifically from the species Sinensis.

5. The water purification process of claim 1 wherein the antioxidant is a synthetic polyphenol.

6. The water purification process of claim 2 where the first halide chemical is utilized in a dosage of at least 0.4 mg per quart of water.

7. The water purification process of claim 1 where the polyphenol containing the second chemical is a catechin.

8. The water purification process of claim 3 wherein the green tea is pulverized into a powder whose particles are between 10 and 15 microns in diameter or further refined into particles between 5 and 10 microns in diameter or further refined into particles between 1 and 5 microns in diameter.

9. The water purification process of claim 1 wherein the antioxidant and polyphenol-containing second chemical is applied at least 10 minutes after the application of the first halide chemical.

10. The water purification process of claim 1 where the temperature and pressure are at Standard Temperature and Pressure conditions.

11. The water purification process of claim 1 where the temperature is greater than Standard Temperature but less than 100° C.

12. The water purification process of claim 1 where the pressure is greater than Standard Pressure but less than 20 psig.
